(19) United States
(12) Patent Application Publication
(10) Pub. No.: US 2015/0331153 A1
(43) Pub. Date: Nov. 19, 2015

(54) GAS BARRIER FILM, AND METHOD FOR MANUFACTURING SAME

(71) Applicant: CHEIL INDUSTRIES INC., Gumi-si Gyeongsangbuk-do (KR)

(72) Inventors: Se Yeong KANG, Gyeonggi-do (KR); Dae Gyu LEE, Gyeonggi-do (KR); Byung Soo KIM, Gyeonggi-do (KR); Eun Hwa LEE, Gyeonggi-do (KR); Taek Soo KWAK, Gyeonggi-do (KR); Sung Kook KIM, Gyeonggi-do (KR)

(21) Appl. No.: 14/758,460

(22) PCT Filed: Dec. 20, 2013
(86) PCT No.: PCT/KR2013/011970

§ 371 Date: Jun. 29, 2015

(30) Foreign Application Priority Data
Dec. 29, 2012 (KR) 10-2012-0157683

(51) Int. Cl. G02B 1/18; B05D 3/02; B05D 3/14; B05D 1/00

(52) U.S. Cl. CPC G02B 1/18; B05D 1/005; B05D 3/0272; B05D 3/147

(57) ABSTRACT

The present invention relates to a gas barrier film including: an inorganic layer which contains oxygen atoms; and an organic-inorganic mixed layer which contains silica (SiO₂) formed on one surface of the inorganic layer. The inorganic layer has a first area that is adjacent to the organic-inorganic mixed layer; and a second area that is present below the first area in the thickness direction of the inorganic layer. The number of the oxygen (O) atoms in the first area is greater than the number of the oxygen atoms in the second area which is equal in volume to the first area. The gas barrier film is excellent in terms of gas barrier properties, flexibility, transparency, and crack prevention. In addition, the gas barrier film enables non-vacuum wet coating and is thus advantageous in shortening the manufacturing time.

### TECHNICAL FIELD

The present invention relates to a gas barrier film and a method for manufacturing the same.

### BACKGROUND ART

Conventionally, plate glass is generally used as an electrode substrate for liquid crystal display panels, and display members of plasma displays, electroluminescent (EL) displays, fluorescent display boards and light emitting diodes. However, plate glass is likely to be damaged, has no flexibility, and has high specific gravity and a limit in reduction of thickness and weight thereof. To solve such problems, plastic films have attracted attention as a material for replacing the plate glass in the related art. Plastic films are light, not fragile and allow easy reduction in thickness, and are thus used as effective materials capable of coping with size increase of display devices.

However, since plastic films have higher gas permeability than glass, a display device using a plastic film in a substrate is vulnerable to infiltration of oxygen or vapor, causing deterioration in luminous efficacy of the display device.

Accordingly, attempts have been made to minimize influence of oxygen or vapor by forming gas barrier films of an organic or inorganic material on the plastic film. Such gas barrier films are coated onto a surface of the plastic film through vacuum deposition, such as plasma enhanced chemical vapor deposition (PECVD) and sputtering, or a sol-gel process.

Japanese Patent No. 1994-0031850 and No. 2005-0119148 disclose a plastic film which includes an inorganic layer directly coated onto a surface thereof by sputtering. In this case, however, since the plastic film and the inorganic layer are significantly different in terms of coefficient of elasticity, coefficient of thermal expansion, radius of curvature, and the like, cracks are created at an interface therebetween due to stress resulting from bending or application of heat or repetitive force from outside, thereby causing easy delamination of the inorganic layer from the plastic film. Further, Moreover, since a typical gas barrier film is formed through deposition in a high vacuum, expensive equipment is required and high vacuum degree requires evacuation for a long period of time, thereby providing economic infeasibility.

As a method of forming a barrier layer other than deposition under high vacuum, Korean Patent No. 2005-0068025 discloses a display substrate which has significantly enhanced gas barrier performance as well as mechanical properties such as heat resistance by including a polyimide-based nano-composite film obtained by a process wherein a nano-composite solution including polyimide or a precursor thereof and nanoscale layered silicates evenly dispersed therein is coated onto a surface of a typical plastic substrate, followed by drying and heat treatment. However, the polyimide-based nano-composite film has a water vapor transmission rate of 3.36 g/m²/day and is thus not suitable for use as a gas barrier film.

### DISCLOSURE

### Technical Problem

It is one aspect of the present invention to provide a barrier film, which has excellent gas barrier performance and exhibits excellent properties in terms of flexibility, transparency, and crack prevention.

It is another aspect of the present invention to provide a method for manufacturing a gas barrier film which allows non-vacuum wet coating, thereby shortening fabrication time.

It is a further aspect of the present invention to provide a flexible display which includes the gas barrier film as set forth above.

### Technical Solution

One aspect of the present invention relates to a gas barrier film, which includes: an inorganic layer containing oxygen atoms; and an organic-inorganic hybrid layer formed on one surface of the inorganic layer and containing silica (SiO₂), wherein the inorganic layer includes a first area adjacent to the organic-inorganic hybrid layer and a second area located below the first area in a thickness direction of the inorganic layer, and the first area contains more oxygen (O) atoms than the second area in the same volume.

Another aspect of the present invention relates to a method for manufacturing a gas barrier film, which includes: forming an inorganic layer on one surface of a substrate; and forming an organic-inorganic hybrid layer containing silica on one surface of the inorganic layer by coating a coating solution including about 1% by weight (wt %) to about 10 wt % of hydrogenated polysilazane or hydrogenated polysiloxazane (A), about 0.1 wt % to about 1 wt % of polysilsesquioxane (B), and about 89 wt % to about 99 wt % of a solvent (C) onto the one surface of the inorganic layer, followed by curing.

A further aspect of the present invention relates to a flexible display having the gas barrier film as set forth above formed on a flexible substrate.

### Advantageous Effects

The present invention provides a gas barrier film which has excellent gas barrier performance and exhibits excellent properties in terms of flexibility, transparency, and crack prevention, and a method for manufacturing the same which allow non-vacuum wet coating, thereby shortening fabrication time.

### DESCRIPTION OF DRAWINGS

FIG. 1 is a schematic sectional view of a gas barrier film according to one embodiment of the present invention.

FIG. 2 is a sectional view of an inorganic layer and an organic-inorganic hybrid layer of a barrier film according to one embodiment of the present invention.

### BEST MODE

Hereinafter, embodiments of the present invention will be described in detail with reference to the accompanying drawings. It should be understood that the present invention is not limited to the following embodiments and may be embodied in different ways, and that the following embodiments are given to provide complete disclosure of the invention and to provide thorough understanding of the invention to those skilled in the art. It should be noted that the drawings are not to precise scale and some of the dimensions, such as width, length, thickness, and the like, are exaggerated for clarity of description in the drawings. Although some elements are illustrated in the drawings for convenience of description, other elements will be easily understood by those skilled in the art. It should be noted that all the drawings are described from the viewpoint of the observer. It will be understood that, when an element is referred to as being “on” another element, the element can be directly formed on the other element, or intervening element(s) may also be present therebetween. In addition, it should be understood that the present invention may be embodied in different ways by those skilled in the art without departing from the scope of the present invention. Like components will be denoted by like reference numerals throughout the drawings.

Gas Barrier Film

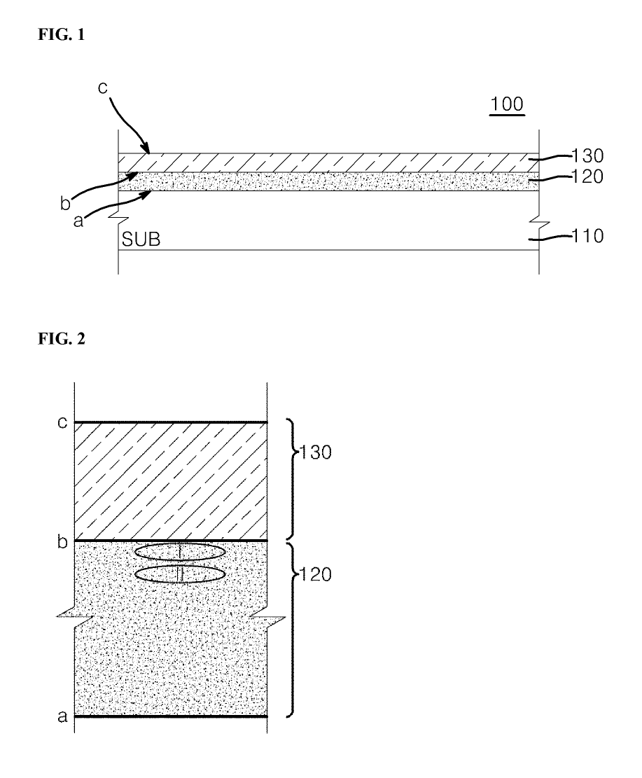

One aspect of the present invention relates to a barrier film. FIG. 1 is a sectional view of a barrier film according to the present invention. The barrier film includes a substrate 110; an inorganic layer 120; and an organic-inorganic hybrid layer 130 containing silica.

Although not particularly limited, a highly heat resistant plastic substrate having excellent heat resistance and low coefficient of thermal expansion may be used as the substrate 110. For example, the substrate may include at least one selected from the group consisting of polyethersulfone, polycarbonate, polyimide, polyether imide, polyacrylate, polyethylene naphthalate, and polyester films, without being limited thereto.

The substrate 110 may have a thickness of about 20 μm to about 150 μm, specifically about 70 μm to about 100 μm. Within this range, the substrate can exhibit excellent properties in terms of mechanical strength, flexibility, transparency, and heat resistance suitable.

The substrate 110 may further include inorganic fillers. The inorganic fillers may include, for example, at least one particle selected from the group consisting of silica, plate-shaped or spherical glass flakes, and nanoclay, or glass cloths. The substrate 110 may have a coefficient of thermal expansion (CTE) of about 20 ppm/° C. to about 100 ppm/° C.

The inorganic layer 120 may be formed on one surface of the substrate 110 to guarantee gas barrier performance. The inorganic layer 120 may include silicon, aluminum, magnesium, zinc, tin, nickel, titanium, tantalum, oxides, carbides, oxy-nitrides, or nitrides thereof, or mixtures thereof.

Although the inorganic layer 120 may be formed by any typical method such as deposition, coating, and the like, deposition may be used to guarantee sufficient gas barrier performance and to obtain a uniform thin film. Examples of deposition may include vacuum evaporation, ion plating, physical vapor deposition (PVD) such as sputtering, and chemical vapor deposition (CVD).

The inorganic layer 120 may have a thickness of about 5 nm to about 500 nm, specifically about 10 nm to about 200 nm.

The organic-inorganic hybrid layer 130 may be formed on one surface of the inorganic layer 120. The organic-inorganic hybrid layer 130 may contain silica originating from hydrogenated polysilazane or hydrogenated polysiloxazane and polysilsesquioxane. When the inorganic layer is deposited alone, it is difficult to guarantee flexibility of the barrier film, and a surface of the inorganic layer is likely to suffer from cracking, which can cause deterioration in luminance of a display device due to penetration of oxygen or water vapor. However, when the organic-inorganic hybrid layer containing silica is further formed on the inorganic layer, it is possible to enhance barrier properties while providing flexibility to the film, thereby improving cracking characteristics.

The organic-inorganic hybrid layer 130 may be formed by coating a coating solution including polysiloxazane or polysilazane, polysilsesquioxane, and an organic solvent onto the surface of the inorganic layer, followed by baking and curing. Here, polysiloxazane or polysilazane can react with moisture and hydrogen in the atmosphere to be modified into silica (SiO₂). Besides silica, the organic-inorganic hybrid layer 130 may further include an organic material by virtue of a functional group bonded to polysilsesquioxane. The functional group may be a substituted or unsubstituted C₁ to C₃₀ alkyl group, a cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or combinations thereof.

Silica (SiO₂) in the organic-inorganic hybrid layer 130 can move onto the surface of the inorganic layer or into the inorganic layer to heal defects present in the inorganic layer throughout the coating process. For example, silica can fill voids present in the surface or inside of the inorganic layer. Next, detailed descriptions thereof will be given with reference to the accompanying drawing.

FIG. 2 is an enlarged sectional view of an inorganic layer and an organic-inorganic hybrid layer of a barrier film according to one embodiment of the present invention. Referring to FIG. 2, the inorganic layer 120 includes a first area (I) and a second area (II) divided in a thickness direction thereof, wherein the first area (I) may be located closer to the organic-inorganic hybrid layer 130 than the second area (II), and the second area (II) may be located below the first area (I) in the thickness direction of the inorganic layer 120. Here, the first area (I) contains more oxygen (O) atoms than the second area (II) in the same volume. In the inorganic layer 120, an area closer to an interface between the inorganic layer 120 and the organic-inorganic hybrid layer 130 may have an increased number of oxygen atoms. In other words, the number of oxygen atoms present in an interface region between the inorganic layer 120 and the organic-inorganic hybrid layer 130 may be greater than the number of oxygen atoms present in a region in the inorganic layer 120 having the same volume as the interface region. Here, the interface region refers to a region which is adjacent to the interface and includes the interface between the inorganic layer 120 and the organic-inorganic hybrid layer 130.

In the present invention, the organic-inorganic hybrid layer containing silica is formed by a process of applying the coating solution, followed by baking and curing. The process allows transformation into a ceramic material by transforming siloxane compounds such as hydrogenated polysilazane, hydrogenated polysiloxazane, or polysilsesquioxane into silica (SiO₂). When transformation into the ceramic material is achieved as above, silica (SiO₂) of the organic-inorganic hybrid layer can penetrate the inorganic layer to fill voids present within the inorganic layer as well as to heal defects on the interface between the inorganic layer and the organic-inorganic hybrid layer. Thus, as shown in a graph of FIG. 2, the first area of the inorganic layer adjacent to the organic-inorganic hybrid layer may have a greater atomic percent ratio of silicon (Si) to oxygen than the second area. This means that defects of the first area have been more completely healed.

The organic-inorganic hybrid layer may have a thickness of about 20 nm to about 3 μm, specifically about 20 nm to about 250 nm. Within this range, the organic-inorganic hybrid layer does not suffer from cracking and can provide excellent gas barrier performance.

The gas barrier film may have a water vapor transmission rate of about 5×10⁻² g/(m²·day) or less, for example, about (1×10⁻³) g/(m²·day) to about (5×10⁻²) g/(m²·day), as measured by the JIS K7129 B method.

Hereinafter, compositions of a coating solution for the organic-inorganic hybrid layer will be described in detail.

Coating Solution for Organic-Inorganic Hybrid Layer

A coating solution for the organic-inorganic hybrid layer containing silica may include hydrogenated polysiloxazane, hydrogenated polysilazane, or a mixture thereof; polysilsesquioxane; and a solvent. Details of each component of the coating solution are as follows:

(A) Hydrogenated Polysiloxazane or Hydrogenated Polysilazane

The coating solution is a composition for a silica layer and may include hydrogenated polysiloxazane, hydrogenated polysilazane, or a mixture thereof.

The hydrogenated polysiloxazane or the hydrogenated polysilazane is transformed into dense silica glass by heating and oxidation and may thus be used for an insulation layer, a membrane, a hard coating, and the like.

The hydrogenated polysiloxazane includes a silicon-nitrogen (Si—N) bond unit and a silicon-oxygen-silicon (Si—O—Si) bond unit therein. The silicon-oxygen-silicon (Si—O—Si) bond unit can reduce shrinkage by relieving stress during curing.

The hydrogenated polysilazane includes a silicon-nitrogen (Si—N) bond unit, a silicon-hydrogen (Si—H) bond unit, and a nitrogen-hydrogen (N—H) bond unit as a backbone.

In both the hydrogenated polysiloxazane and the hydrogenated polysilazane, the (Si—N) bond can be substituted with a (Si—O) bond through baking or curing.

In one embodiment, the hydrogenated polysiloxazane has a unit represented by Formula 1 and a terminal group represented by Formula 2.

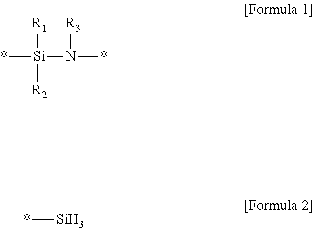

wherein R₁ to R₃ are each independently hydrogen, a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or combinations thereof.

As used herein, the term “substituted” means that at least one hydrogen atom is substituted with a halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or combinations thereof.

The hydrogenated polysiloxazane or the hydrogenated polysilazane may have about 0.2 wt % to about 3 wt % of oxygen. Within this range, the hydrogenated polysiloxazane or the hydrogenated polysilazane can secure sufficient stress relief through the silicon-oxygen-silicon (Si—O—Si) bond in the structure thereof to prevent shrinkage of a cured product upon heat treatment, and the gas barrier layer can be prevented from suffering cracking For example, the hydrogenated polysiloxazane or the hydrogenated polysilazane may contain about 0.4 wt % to about 2.5 wt % of oxygen, specifically about 0.5 wt % to about 2 wt % of oxygen.

Further, the hydrogenated polysiloxazane or the hydrogenated polysilazane has a terminal group capped with hydrogen, and may include about 15 wt % to about 35 wt % of the terminal group represent by Formula 2 based on the total amount of the Si—H bonds in the hydrogenated polysiloxazane or the hydrogenated polysilazane. Within this range, the hydrogenated polysiloxazane or the hydrogenated polysilazane can prevent shrinkage of the cured product by preventing SiH₃ from being converted into SiH₄ and scattering while allowing sufficient oxidation upon curing, and the barrier layer can be prevented from suffering cracking. Preferably, the hydrogenated polysiloxazane or the hydrogenated polysilazane includes about 20 wt % to about 30 wt % of the terminal group represented by Formula 3 based on the total amount of the Si—H bonds in the hydrogenated polysiloxazane or the hydrogenated polysilazane.

The hydrogenated polysiloxazane or the hydrogenated polysilazane may have a weight average molecular weight (Mw) of about 1,000 g/mol to about 5,000 g/mol, for example, about 1,500 g/mol to about 3,500 g/mol. Within this range, it is possible to reduce evaporation loss during heat treatment and to form a dense organic-inorganic hybrid layer by thin film coating.

The hydrogenated polysiloxazane, the hydrogenated polysilazane, or a mixture thereof may be present in an amount of about 0.1 wt % to about 10 wt % based on the total amount of the coating solution. Within this range, it is possible to maintain proper viscosity, whereby the organic-inorganic hybrid layer can be smoothly and uniformly formed without bubbling and voids.

(B) Polysilsesquioxane

The coating solution further includes polysilsesquioxane, which is a composite material wherein an inorganic material and an organic material are chemically combined with each other at a molecular level. The polysilsesquioxane may be represented by general Formula R—SIO_{3/2}, wherein R may be a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxy group, or combinations thereof. Preferably, R is a photopolymerizable group and may be a cationic polymerizable oxetanyl group or a radical polymerizable acrylate group.

The polysilsesquioxane may have a random structure represented by Formula 3, a ladder structure represented by Formula 4, a cage structure represented by Formula 5, or a partial cage structure represented by Formula 6.

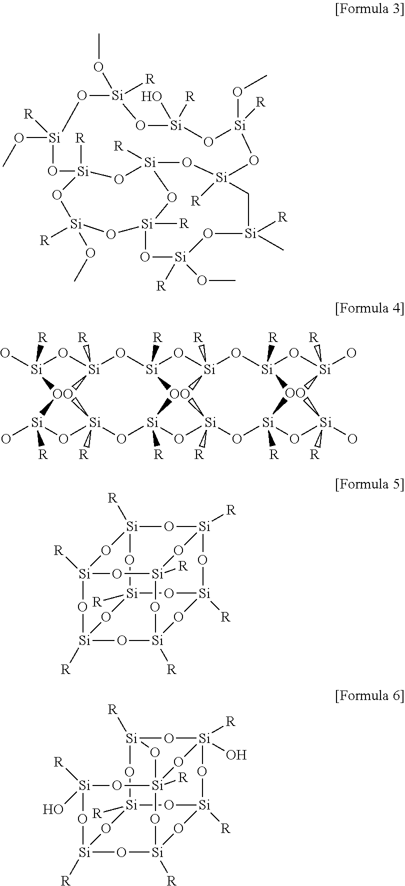

The polysilsesquioxane may be present in an amount of about 0.1 wt % to about 1 wt % based on the total amount of the coating solution. Further, the polysilsesquioxane and the hydrogenated polysiloxazane, the hydrogenated polysilazane, or a mixture thereof may be mixed in a weight ratio of about 1:100 to about 5:100.

Within this range, the organic-inorganic hybrid layer can be prevented from suffering from cracking and deformation, and have enhanced properties in terms of thermal stability, processability, gas permeability, surface hardness, and compatibility with the inorganic layer, which is a gas barrier layer.

(C) Solvent

The solvent may be selected from any solvent which does not react with the hydrogenated polysiloxazane, the hydrogenated polysilazane and the polysilsesquioxane and can dissolve the hydrogenated polysiloxazane. Since a solvent containing OH can react with a siloxane compound, a solvent containing no —OH group is preferably used as the solvent. For example, the solvent may include hydrocarbon solvents such as aliphatic hydrocarbons, alicyclic hydrocarbons, and aromatic hydrocarbons; halogenated hydrocarbon solvents; and ethers such as aliphatic ethers and alicyclic ethers. Specifically, the solvent may include hydrocarbons, such as pentane, hexane, cyclohexane, toluene, xylene, Solvesso, Taben; halogenated hydrocarbons, such as methylene chloride and trichloroethane; and ethers such as dibutyl ether, dioxane, and tetrahydrofuran. The solvent may be suitably selected in consideration of solubility of the siloxane compound or the evaporation rate of the solvent, and a mixture of these solvents may be used

The solvent may be present in an amount of about 89 wt % to about 99 wt % based on the total amount of the coating solution.

The coating solution may further include a thermal acid generator (TAG). The thermal acid generator is an additive for enhancing development of the hydrogenated polysiloxazane while preventing contamination due to the uncured hydrogenated polysiloxazane, and allows the hydrogenated polysiloxazane to be developed at a relatively low temperature. Although the thermal acid generator may be selected from any compound capable of generating hydrogen ions (H⁺) by heat, it is desirable that the thermal acid generator be selected from compounds capable of being activated at about 90° C. or more to generate sufficient hydrogen ions and exhibit low volatility. Examples of the thermal acid generator may include nitrobenzyl tosylate, nitrobenzyl sulfonate, phenol sulfonate, and combinations thereof. The thermal acid generator may be present in an amount of about 25 wt % or less, for example, about 0.01 wt % to about 20 wt % based on the total amount of the coating solution. Within this range, the thermal acid generator enables development of the hydrogenated polysiloxazane at a relatively low temperature. Here, in order to provide superior gas barrier characteristics, the coating solution does not contain an organic component.

The coating solution may further include a surfactant. According to the present invention, any surfactant may be used without limitation, and examples of the surfactant may include nonionic surfactants, such as polyoxyethylene alkyl ethers including polyoxyethylene lauryl ether, polyoxyethylene stearyl ether, polyoxyethylene ether, polyoxyethylene oleyl ether, and the like, polyoxyethylene alkyl allyl ethers including polyoxyethylene nonylphenol ether, and the like, polyoxyethylene polyoxypropylene block copolymers, polyoxyethylene sorbitan fatty acid esters including sorbitan monolaurate, sorbitan monopalmitate, sorbitan monostearate, sorbitan monooleate, and the like; fluorine surfactants, such as F-Top EF301, EF303, EF352 (Tohchem Products Co., Ltd.), Megapack F171, F173 (Dainippon Ink & Chemicals Inc.), Fluorad FC430, FC431 (Sumitomo 3M Co., Ltd.), Asahi Guard AG710, Saffron S-382, SC101, SC102, SC103, SC104, SC105, SC106 (Asahi Glass Co., Ltd.), and the like; silicone surfactants, such as an organosiloxane polymer KP341 (Shin-Etsu Chemical Co., Ltd.), and the like. The surfactant may be present in an amount of about 10 wt % or less, for example, about 0.001 wt % to about 5 wt % based on the total amount of the coating solution. In order to provide further enhanced gas barrier performance, it is desirable that the surfactant include no organic component.

Method for Manufacturing as Barrier Film

A method for manufacturing a gas barrier film according to one embodiment of the present invention may include: forming an inorganic layer on one surface of a substrate; and forming an organic-inorganic hybrid layer containing silica one surface of the inorganic layer by coating the coating solution for an organic-inorganic hybrid layer as set forth above onto the one surface of the inorganic layer, followed by curing.

The coating solution may be coated onto the inorganic layer by roll coating, spin coating, dip coating, flow coating, or spray coating, without being limited thereto.

The coating solution may be coated to a thickness of, for example, about 0.01 μm to about 3 μm, without being limited thereto. Within this range, the coating solution provides excellent gas barrier performance without cracking

Then, the resultant coating layer may be cured through UV irradiation, plasma treatment, heat treatment, or a combination thereof. Here, “curing” means a process of transformation into a ceramic material through transformation of a siloxane compound such as hydrogenated polysiloxazane, hydrogenated polysilazane, or polysilsesquioxane into silica.

In one embodiment, the coating layer may be subjected to heat treatment. Here, although heating temperature is determined depending upon heat resistance of a base film, the coating layer may be subjected to heat treatment at a temperature of about 120° C. or less when the base film is formed of a material having relatively low heat resistance such as PET and PEN. In addition, when a planarization layer or a buffer layer is coated onto a plastic film, the heating temperature may be set in consideration of heat resistance of these layers. Although the siloxane compound can be transformed into a ceramic material through such heat treatment, it is difficult to achieve sufficient transformation into a ceramic material only by heating to about 150° C. or less.

Thus, UV irradiation, plasma treatment, or drying at high temperature may be applied in order to increase transformation rate into silica.

UV irradiation may be, for example, vacuum UV irradiation. Specifically, for vacuum UV irradiation, UV light at a wavelength of about 100 nm to about 200 nm may be used under vacuum conditions. In vacuum UV irradiation, irradiance and radiant exposure of UV light may be suitably adjusted. In one embodiment, vacuum UV irradiation may be performed at an irradiance of about 10 mW/cm² to about 200 mW/cm² and at a radiant exposure of about 100 mJ/cm² to about 6,000 mJ/cm², for example, about 1000 mJ/cm² to about 5,000 mJ/cm².

Plasma treatment may be performed under atmospheric pressure or in a vacuum. However, it is convenient to perform plasma treatment under atmospheric pressure in order to secure continuous plasma treatment while reducing process costs. In plasma treatment under atmospheric pressure, nitrogen gas, oxygen gas or a mixture thereof may be used. For example, the base film is irradiated with plasma, which is generated by allowing the gas to pass through a space between two electrodes. Alternatively, with the base film placed between the two electrodes, plasma is generated by allowing the gas to pass through a space between two electrodes. Plasma treatment under atmospheric pressure may be performed at a gas flow rate of about 0.01 L/min to about 100 L/min and at a base material feeding speed of about 0.1 m/min to about 1,000 m/min.

For vacuum plasma treatment, nitrogen gas, oxygen gas or a mixture thereof may be used. For example, with an electrode or a waveguide placed in a closed space maintained in a vacuum of about 20 Pa to about 50 Pa using oxygen gas, direct current, alternating current, radio wave, or microwave power may be applied to the electrode or the waveguide to generate plasma. Vacuum plasma treatment may be performed at a power output of about 100 W to about 5,000 W for about 1 to about 30 minutes.

In addition, the hydrogenated polysiloxazane may be cured by heat treatment at high humidity and low temperature. In this case, heat treatment may be performed at a temperature of about 40° C. to about 350° C. and a relative humidity of 50% to 100%. Within this range, it is possible to achieve sufficient transformation of the hydrogenated polysiloxazane into the ceramic material without cracking

Hereinafter, the present invention will be described in more detail with reference to some examples. However, it should be understood that these examples are provided for illustration only and are not to be in any way construed as limiting the present invention. A description of details apparent to those skilled in the art will be omitted for clarity.

### Mode for Invention

### EXAMPLES

Details of components used in Examples and Comparative Examples and methods of evaluating properties are as follows:

Base film: A polyethylene terephthalate (PET) film was used.

Polysilsesquioxane: OX-SQ-TX-100 (Toagosei Chemical Industry) was used.

Solvent: Butyl acetate (SAMCHUN PURE CHEMICAL IND. CO., LTD.) was used.

Drying conditions: 80° C./3 min

UV irradiation conditions: 1500 mJ/cm² (Low Pressure UV Lamp)

Heat curing conditions: 120° C./10 min

Coating thickness: 50 nm to 250 nm (spin coating)

SiOₓN was deposited to a thickness of 100 nm onto a PET base film by the following method. First, the PET base film was placed in a chamber of a batch type sputtering apparatus and then silicon oxynitride, as a target, was disposed in the chamber. Distance between silicon oxynitride and the PET base film was 50 mm. Oxygen and argon were used as gases added during film formation. The chamber was evacuated to a vacuum of 2.5×10⁻⁴ Pa, followed by RF magnetron sputtering at a power input of 1.2 KW while introducing oxygen gas and argon gas at flow rates of 10 standard cubic centimeter per minute (sccm) and 30 sccm, respectively, thereby forming a 100 nm thick inorganic layer, which is a silicon oxynitride film, on the PET base film.

### Example 1

A coating solution obtained by mixing hydrogenated polysilazane or hydrogenated polysiloxazane and polysilsesquioxane in a ratio of 100:10 was coated onto the 100 nm thick SiOₓN_{y} inorganic layer by spin coating. Spin coating was performed at 1,000 rpm for 20 seconds. Then, the coating layer was subjected to drying in a convection oven at 80° C. for 3 minutes, followed by UV irradiation at an irradiance of 14 mW/cm² and an radiant exposure of 1,500 mJ/ cm² using a vacuum UV irradiator (Model CR403, SMT Co., Ltd.) and then drying in a convection oven at 120° C. for 10 minutes.

### Example 2

A gas barrier film was fabricated in the same manner as in Example 1 except that hydrogenated polysilazane and hydrogenated polysiloxazane and polysilsesquioxane were mixed in a ratio of 100:8.

### Example 3

A gas barrier film was fabricated in the same manner as in Example 1 except that hydrogenated polysilazane and hydrogenated polysiloxazane and polysilsesquioxane were mixed in a ratio of 100:4.

### Example 4

A gas barrier film was fabricated in the same manner as in Example 1 except that hydrogenated polysilazane and hydrogenated polysiloxazane and polysilsesquioxane were mixed in a ratio of 100:1.

### Comparative Example 1

A coating solution obtained by mixing hydrogenated polysilazane and hydrogenated polysiloxazane was coated to a thickness of 250 nm onto a PET film (Cheil Industries) with SiOₓ and SiNₓ deposited to a thickness of 100 nm by spin coating. Spin coating was performed at 1,000 rpm for 20 seconds. Then, the coating layer was subjected to drying in a convection oven at 80° C. for 3 minutes, followed by UV irradiation at an irradiance of 14 mW/cm² and an radiant exposure of 1,500 mJ/cm² using a vacuum UV irradiator (Model CR403, SMT Co., Ltd.) and then drying in a convection oven at 120° C. for 10 minutes.

### Comparative Example 2

A gas barrier film was fabricated in the same manner as in Comparative Example 1 except that no coating layer was formed on the PET film (Cheil Industries) with SiOₓ and SiNₓ deposited to a thickness of 100 nm.

### Comparative Example 3

A gas barrier film was fabricated in the same manner as in Comparative Example 1 except that the coating solution obtained by mixing hydrogenated polysilazane and hydrogenated polysiloxazane was spin coated to a thickness of 100 nm.

TABLE 1

| | | Thickness of hydrogenated | Mixing ratio of organic material | | | | |
|---|---|---|---|---|---|---|---|
| | | polysilazane and | to inorganic material | | | | |
| | Thickness of | hydrogenated | (hydrogenated polysilazane | | | | |
| | organic layer | polysiloxazane | and hydrogenated | WVTR | | | |
| Item | (nm) | coating layer (nm) | polysiloxazane:polysilsesquioxane) | (g/m²/day) | Cracking | Adhesion | Appearance |
| Example 1 | 100 | — | 100:10 | 0.002 | x | 100/100 | ◯ |
| Example 2 | 100 | — | 100:8 | 0.005 | x | 100/100 | Δ |
| Example 3 | 100 | — | 100:4 | 0.010 | Δ | 90/100 | Δ |
| Example 4 | 100 | — | 100:1 | 0.042 | Δ | 80/100 | Δ |
| Comparative | 100 | 250 | — | 1.78 | Δ | 80/100 | X |
| Example 1 | | | | | | | |
| Comparative | 100 | — | — | 3.12 | ◯ | 0/100 | X |
| Example 2 | | | | | | | |
| Comparative | 100 | 100 | — | 0.85 | Δ | 90/100 | Δ |
| Example 3 | | | | | | | |

Evaluation of Properties

(1) Water vapor transmission rate (WVTR): Water vapor transmission rate was measured at 40° C. and 90% RH using a water vapor transmission rate tester (PERMATRAN-W 3/31, MOCON Co., Ltd., US) in accordance with the B method (IR sensor method) described in JIS K7129 (edited in 2000). For each of Examples and Comparative Examples, two specimens were prepared. Measurements for the specimens were averaged. Results are shown in Table 1.

(2) Cracking: Cracking of the coating layer of each specimen was checked using an optical microscope.

Good (×): No cracking was observed.

Normal (Δ): Cracking was partially observed in the coating layer.

Bad (◯): Cracking was observed throughout the coating layer.

(3) Adhesion: A 3M tape was attached to each specimen with 10×10 notches formed therein to be cut into 100 sections each having a size of 1 mm×1 mm, followed by detaching the tape and counting the number of remaining sections. Results are shown in Table 1.

(4) Appearance: Change in appearance such as whitening or delamination was observed with the naked eye.

Good (◯): Neither appearance defects such as whitening nor delamination was observed on an outer surface of the coating layer.

Normal (Δ): Appearance defects such as whitening and delamination were partially observed on the outer surface of the coating layer.

Poor (×): Appearance defects such as whitening and delamination were observed throughout the outer surface of the coating layer.

As shown in Table 1, it can be seen that the gas barrier films of Examples 1 to 4 had lower water vapor transmission rate and exhibited better adhesion and appearance than those of Comparative Examples 1 to 3. Higher water vapor transmission rate indicates more cracking on the outer surface of the organic-inorganic hybrid layer. This can be verified from the fact that the gas barrier film of Examples 1 to 4, which had relatively low water vapor transmission rate, suffered from less cracking than those of Comparative Examples 1 to 3.

1. A gas barrier film comprising:
an inorganic layer containing oxygen atoms; and
an organic-inorganic hybrid layer formed on one surface of the inorganic layer and containing silica (SiO₂),
wherein the inorganic layer comprises a first area adjacent to the organic-inorganic hybrid layer and a second area located below the first area in a thickness direction of the inorganic layer, and the first area contains more oxygen (O) atoms than the second area in the same volume.

2. The gas barrier film according to claim 1, wherein the barrier film has a water vapor transmission rate of about 5×10⁻² g/(m²·day) or less as measured in accordance with JIS K7129 B.

3. The gas barrier film according to claim 1, wherein the inorganic layer has a thickness of about 5 nm to about 500 nm and the organic-inorganic hybrid layer has a thickness of about 20 nm to about 3 μm.

4. The gas barrier film according to claim 1, wherein the organic-inorganic hybrid layer originates from hydrogenated polysilazane or hydrogenated polysiloxazane, and polysilsesquioxane.

5. The gas barrier film according to claim 4, wherein the polysilsesquioxane is represented by general Formula R—SIO_{3/2}, wherein R is a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or a combination thereof.

6. The gas barrier film according to claim 5, wherein R is a cationic polymerizable oxetanyl group or a radical polymerizable acrylate group.

7. The gas barrier film according to claim 1, wherein the organic-inorganic hybrid layer is formed of a coating solution comprising about 1 wt % to about 10 wt % of hydrogenated polysilazane or hydrogenated polysiloxazane (A); about 0.1 wt % to about 1 wt % of polysilsesquioxane (B); and about 89 wt % to about 99 wt % of a solvent (C).

8. The gas barrier film according to claim 4, wherein the hydrogenated polysilazane or the polysiloxazane has a unit represented by Formula 1 and a terminal group represented by Formula 2 in a structure thereof. 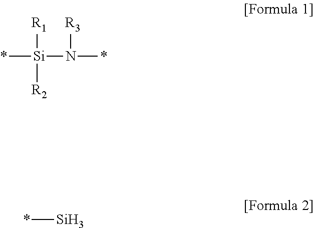
where R₁ to R₃ are each independently hydrogen, a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or a combination thereof.

9. The gas barrier film according to claim 4, wherein the hydrogenated polysiloxazane or the hydrogenated polysilazane contains about 0.2 wt % to about 3 wt % of oxygen.

10. The gas barrier film according to claim 8, wherein the hydrogenated polysilazane or the polysiloxazane contains about 15 wt % to about 35 wt % of the terminal group represented by Formula 2, based on the total amount of Si—H bonds.

11. The gas barrier film according to claim 4, wherein the hydrogenated polysiloxazane or the hydrogenated polysilazane has a weight average molecular weight (Mw) of about 1,000 g/mol to about 5,000 g/mol.

12. The gas barrier film according to claim 1, wherein the inorganic layer comprises silicon, aluminum, magnesium, zinc, tin, nickel, titanium, tantalum, oxides, carbides, oxynitrides or nitrides thereof, or mixtures thereof.

13. A method for manufacturing a gas barrier film, comprising:
forming an inorganic layer on one surface of a substrate; and
forming an organic-inorganic hybrid layer containing silica on one surface of the inorganic layer by coating a coating solution comprising about 1 wt % to about 10 wt % of hydrogenated polysilazane or hydrogenated polysiloxazane (A), about 0.1 wt % to about 1 wt % of polysilsesquioxane (B), and about 89 wt % to about 99 wt % of a solvent (C) onto the one surface of the inorganic layer, followed by curing.

14. The method according to claim 13, wherein the curing is performed by UV irradiation, plasma treatment, heat treatment, or a combination thereof.

15. The method according to claim 14, wherein the UV irradiation is performed at an irradiance of about 10 mW/cm² to about 200 mW/cm² and at a radiant exposure of about 100 mJ/cm² to about 6,000 mJ/cm².

16. The method according to claim 14, wherein the plasma treatment is plasma treatment under atmospheric pressure performed at a gas flow rate of about 0.01 L/min to about 100 L/min and at a base material feeding speed of about 0.1 m/min to about 1,000 m/min, or vacuum plasma treatment performed in a vacuum of about 20 Pa to about 50 Pa and at a power output of about 100 W to about 5,000 W.

17. The method according to claim 14, wherein the heat treatment is performed at a temperature of about 40° C. to about 350° C. and a relative humidity of 50% to 100%.

18. The method according to claim 13, wherein the coating is performed by roll coating, spin coating, dip coating, flow coating, or spray coating.

19. The method according to claim 13, wherein the coating thickness ranges from about 0.01 μm to about 3 μm.

20. A flexible display having the gas barrier film according to any one claim 1 formed on a flexible substrate.
